(19) United States
(12) Patent Application Publication
(10) Pub. No.: US 2016/0265659 A1
(43) Pub. Date: Sep. 15, 2016

(54) CROSSHEAD FOR A PISTON ROD

(71) Applicant: Nuovo Pignone Srl, Florence (IT)

(72) Inventors: Riccardo Bagagli, Florence (IT); Francesco Chiesi, Florence (IT); Fulvio D'urso, Florence (IT); Leonardo Tognarelli, Florence (IT)

(21) Appl. No.: 15/032,914

(22) PCT Filed: Oct. 27, 2014
(86) PCT No.: PCT/EP2014/073004

§ 371 Date: Apr. 28, 2016

(30) Foreign Application Priority Data
Oct. 29, 2013 (IT) CO2013A000054

(51) Int. Cl. F16J 1/14; F16J 1/12; F04B 39/00

(52) U.S. Cl. CPC F16J 1/14; F04B 39/0022; F16J 1/12

(57) ABSTRACT

A crosshead for a piston rod comprises a main body having a first seat and a second seat being configured to hold a connecting rod, the second seat being configured to hold a piston rod; the main body comprising a linking portion defining at least partially the first seat and the second seat for holding respectively the connecting rod and the piston rod; the main body comprising a closing portion defining at least partially the second seat and being configured to secure the piston rod inside the second seat.

### BACKGROUND

Embodiments of the invention relate to a crosshead for a piston rod, specifically in a reciprocating compressor.

In the technical field of reciprocating machines (i.e. machines having a piston moving inside a cylinder such as, for example, internal combustion engines) the piston is usually connected to a crankshaft directly via a connecting rod. Specifically, the connecting rod is linked to the crankshaft via a crankpin. In this arrangement, however, the sideways forces from the connecting rod are transmitted directly to the piston, as the crankpin (and thus the direction the force is applied) moves from side to side with the rotary motion of the crankshaft.

These transverse forces are tolerable in a smaller reciprocating machine. However, in a larger one, such as for example a large reciprocating compressor, this would result in much greater forces, consequently causing an intolerable degree of wear on the piston and cylinder, as well as increasing overall friction.

Therefore, it becomes necessary to decouple the transverse movement of the crankpin from the axial movement of the piston. To perform this function, a crosshead links a piston rod (which is part of the piston) with a connecting rod (which is linked to the crankshaft via the crankpin). The sideways forces transmitted by the connecting rod are absorbed by the crosshead itself, thus allowing the piston rod to move along its axis with negligible transverse load.

Such crosshead is known in the state of the art. The crosshead comprises a main body having a first end facing the crankshaft and a second end facing the piston. A connecting rod is hinged on the first end, thus connecting it to the crankshaft. A piston rod is attached to the second end. Specifically, the piston rod is engaged into a receptacle of a flange, and it is retained therein primarily by mechanical interference. The flange itself is bolted onto the second end of the main body. Additionally, crosshead is provided with sliding shoes attached to the main body and slidably engaged on an internal wall of the cylinder. The sliding shoes themselves absorb the above mentioned sideway forces, allowing the crosshead to maintain the alignment with respect to the longitudinal axis of the piston.

Several disadvantages are apparent in the above described prior art crosshead. The crosshead itself is a particularly complex device, which necessitates a lot of components that need to be machined within strict tolerances. The assembly procedure is also long and complicated, as it is necessary to bolt the piston rod to the flange before the flange itself can be connected to the main body of the crosshead. Specifically, a counterbolt is screwed onto the threaded end of the piston rod, so as to secure firmly the piston rod onto the flange.

### BRIEF SUMMARY OF THE INVENTION

A first embodiment of the invention relates to a crosshead for a piston rod comprising a main body. The main body has a first and a second seat in order to hold a connecting rod and a piston rod respectively. The main body comprises a linking portion, which defines at least partially the first and the second seat. The main body also comprises a closing portion, which defines at least partially the second seat and is configured to secure the piston rod inside the second seat.

This embodiment achieves several advantages over the prior art. Indeed, the two portions can retain the piston rod purely by mechanical interference, removing the need for a screwed counterbolt.

Also, the number of components is reduced, along with their complexity. This simplifies the assembly of the crosshead.

An embodiments of the present invention is also embodied in a method for assembling a crosshead according to the first embodiment. The method comprises the steps of joining the linking and the closing portions while placing a piston rod inside the second seat. Securing the two portions together, more particularly with a fastening element.

This embodiment is advantageous over the prior art, because there is no need to force the piston rod inside a precisely sized receptacle. Also, screwing the counterbolt directly over the piston rod is no longer necessary, as the load applied by the fastening element is sufficient to hold it in place.

### BRIEF DESCRIPTION OF THE DRAWINGS

Further details and specific embodiments will refer to the attached drawings, in which:

FIG. 1 is a perspective view of a crosshead for a piston rod according to an embodiment of the present invention;

FIG. 2 is an exploded perspective view of the crosshead of FIG. 1;

FIG. 3 is a sectional view of the crosshead of FIGS. 1 and 2;

FIGS. 4A and 4B are plan views of the crosshead according to respective embodiments of the present invention;

FIGS. 5A, 5B, 5C, and 5D are longitudinal sectional views of a detail of the crosshead of FIG. 1 according to different embodiments of the present invention.

### DETAILED DESCRIPTION

The following description of exemplary embodiments refer to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

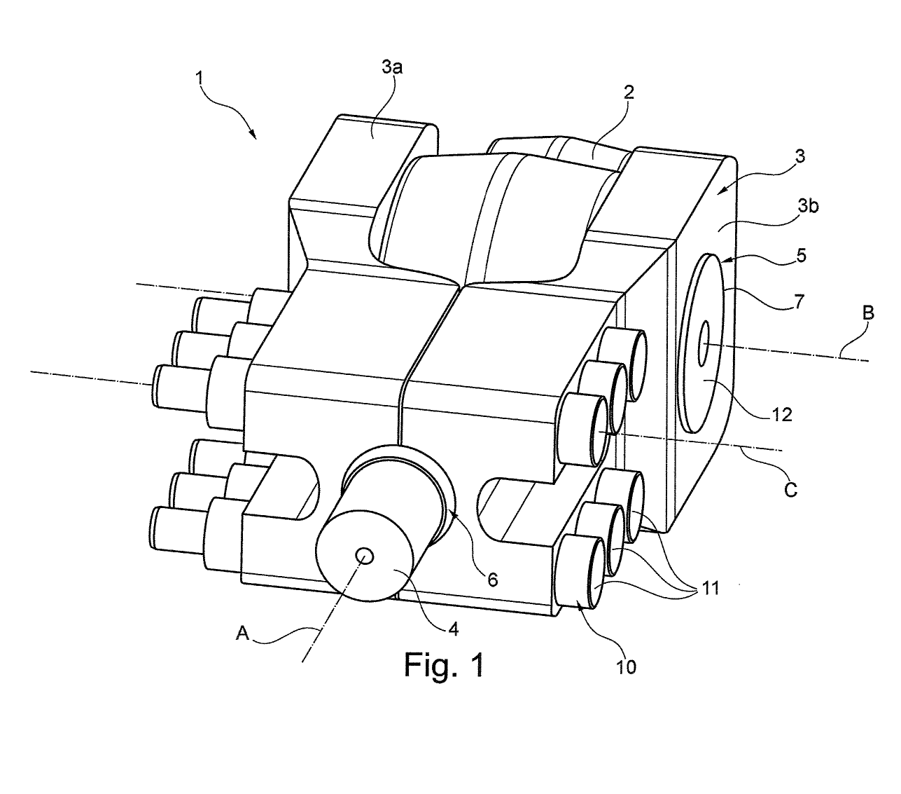

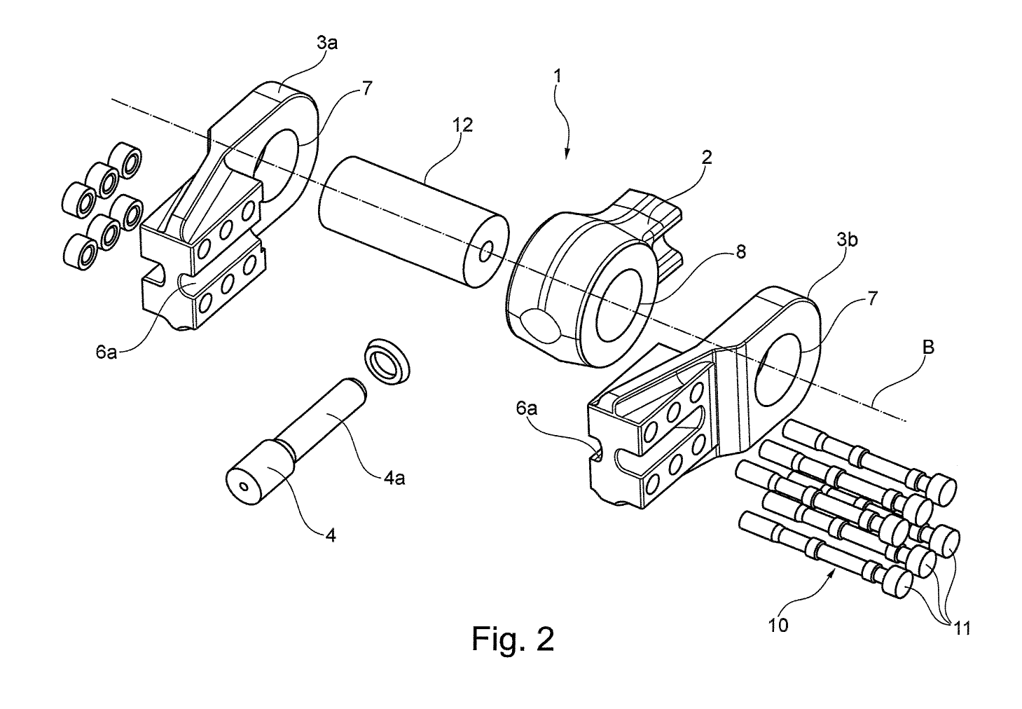

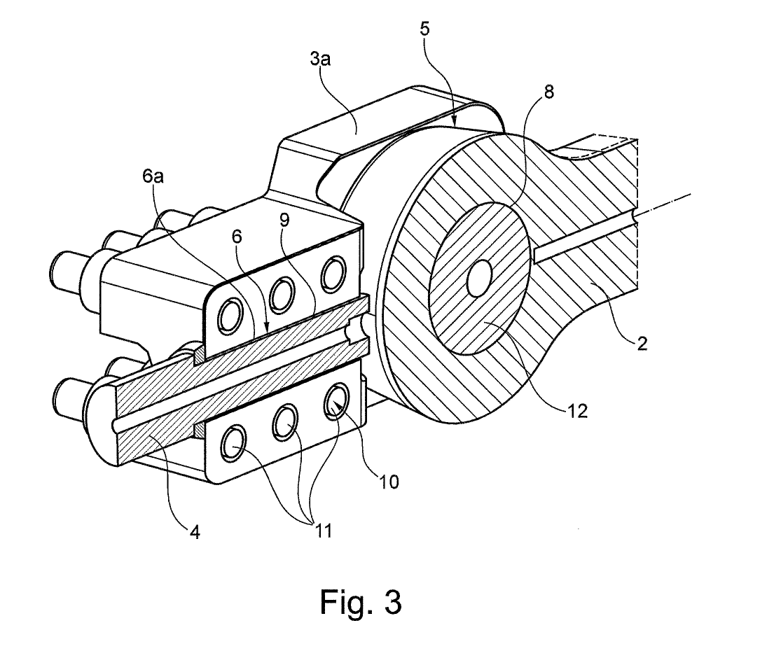

Referring to the attached figures, with the number 1 is indicated a crosshead for a piston rod according to an embodiment of the present invention. The crosshead 1 has the purpose of connecting comprises a main body 3. The main body 3 is used to link a connecting rod 2 with a piston rod 4, as shown for example in FIG. 1.

Indeed, the main body 3 has a first 5 and a second seat 6. The first seat 5 is configured to hold the connecting rod 2. The second seat 6 is configured to hold the piston rod 4. In an embodiment, the first 5 and the second seat 6 are positioned on opposite ends of the main body 3.

The main body 3 has a longitudinal axis “A”, along which the first 5 and the second seat 6 are substantially aligned. Indeed, the longitudinal axis “A” is the longitudinal axis of the piston rod 4. In other words, the longitudinal axis “A” identifies the direction along which the crosshead 1 moves during normal functioning. The main body 3 also has a hinge axis “B” in the first seat 5, around which the connecting rod 2 can rotate. The hinge axis “B” is in an embodiment perpendicular to the longitudinal axis “A”.

The crosshead 1 also comprises sliding shoes (not shown) attached to the main body 3 and designed to allow a reciprocating movement along the longitudinal axis “A”. The sliding shoes will not be further described, as they are themselves known to the person skilled in the art.

In detail, the main body 3 comprises a linking portion 3a, which defines at least partially the first 5 and the second seat 6. The main body 3 comprises a closing portion 3b, which defines at least partially the second seat 6. The closing portion 3b is configured so as to secure the piston rod 4 inside the second seat 6.

According to the embodiments of the present invention, the shape of the portions 3a, 3b are designed so that, when linked together, they define the main body 3 according to the desired dimensions and specifications.

With regards to the shape of the portions 3a, 3b, there are two different embodiments of the present invention: one in which they are symmetrical and the other one in which they are not.

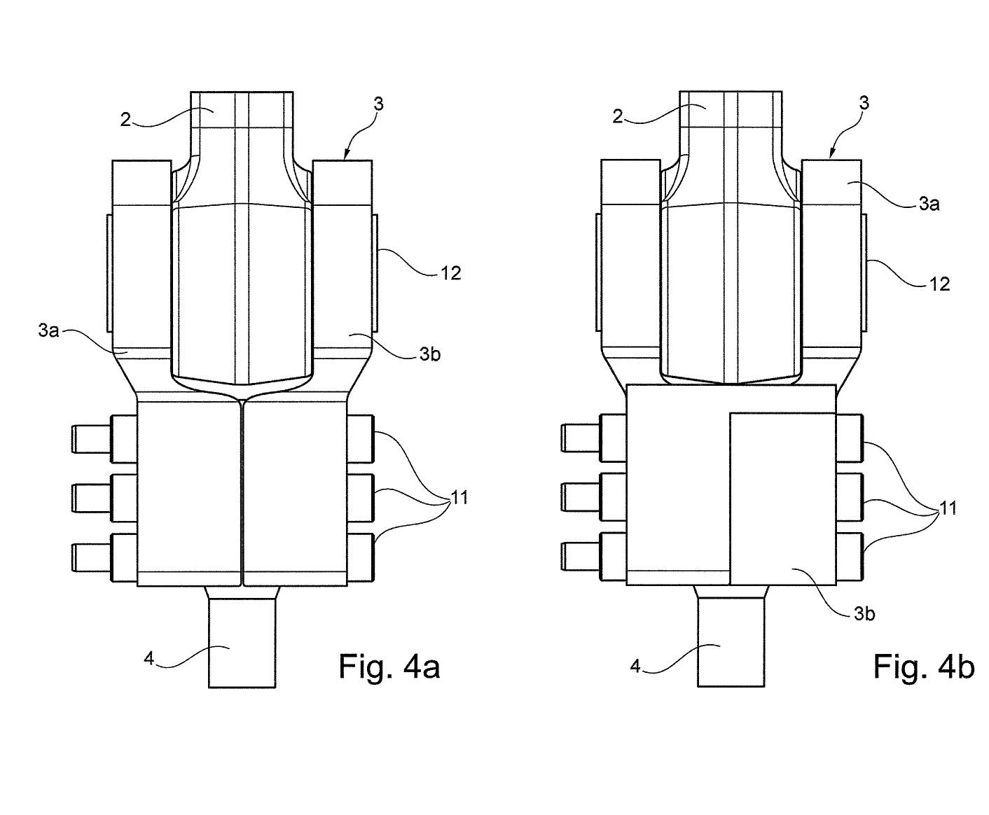

In the embodiment shown in FIG. 4a, the linking portion 3a and the closing portion 3b are substantially symmetrical. The plane of symmetry is perpendicular to the hinge axis B. In other words, the closing portion 3b of the main body 3 also defines at least partially the first seat 5. Indeed, as shown in FIG. 4a, the linking portion 3a and the closing portion 3b are two half-parts of the main body 3. More particularly, in this embodiment the connecting rod 2 and the pin 12 can be integrally formed.

In the embodiment of FIG. 4b, the first seat 5 is located exclusively on the linking portion 3a.

Further details of the linkage between the portions 3a, 3b, will be given in a following part of the present disclosure.

The above mentioned first seat 5 is designed to provide a way to link the crosshead 1 to the connecting rod. In order to achieve this purpose, the main body 3 is provided with two holes 7, more particularly coaxial, which can hold a pin 12. Indeed, the above mentioned hinge axis “B” is defined by the axis of the holes 7. As discussed above, according to different embodiments of the present invention, the pin 12 can be either inserted in a further hole 8 of the connecting rod 2, or can be integrally formed along with the connecting rod 2.

The second seat 6 is formed as a bore 9 in the main body 3. Specifically, the bore 9 develops along the longitudinal axis “A” of the main body 3. With greater detail, the second seat 6 has a lateral surface 6a configured to engage the piston rod 4. Indeed, the lateral surface 6a of the second seat 6 extends at least along the aforementioned longitudinal axis “A”. In other words, the lateral surface 6a develops around the longitudinal axis “A”.

More particularly, the lateral surface 6a is defined by both the linking portion 3a and the closing portion 3b. Specifically, the linking portion 3a and the closing portion 3b have each an angular extension of 180° with respect to the longitudinal axis “A”. In other words, half of the lateral surface 6a is on the linking portion 3a, while the other half is on the closing portion 3b.

Also, the piston rod 4 has an engagement surface 4a configured to contact at least partially the lateral surface 6a of the second seat 6. Therefore, the shape of the engagement surface 4a will be correlated to the shape of the lateral surface 6a of the second seat 6. In other words, the lateral surface 6a is at least partially complementary to the engagement surface 4a of the piston rod 4.

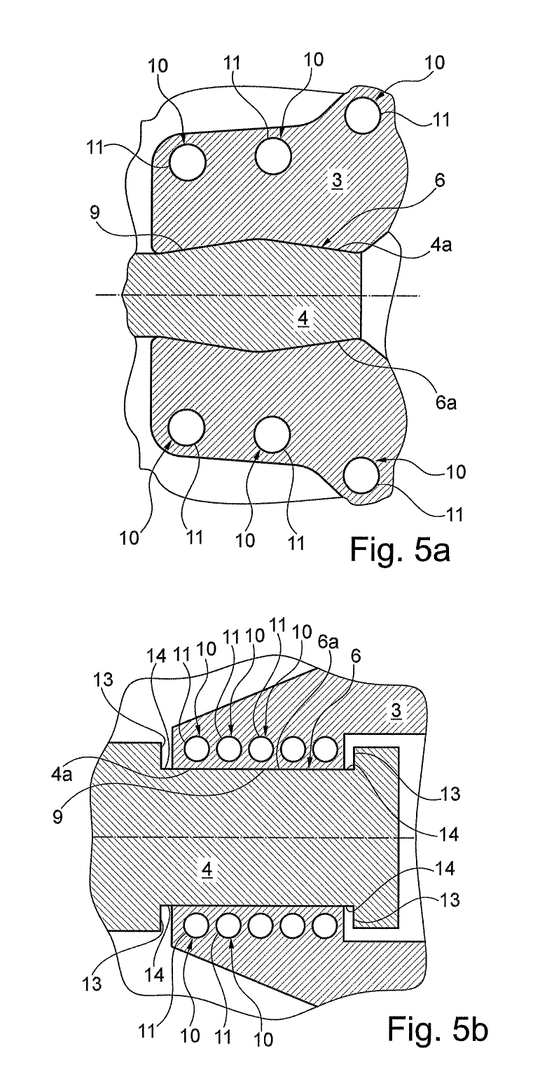

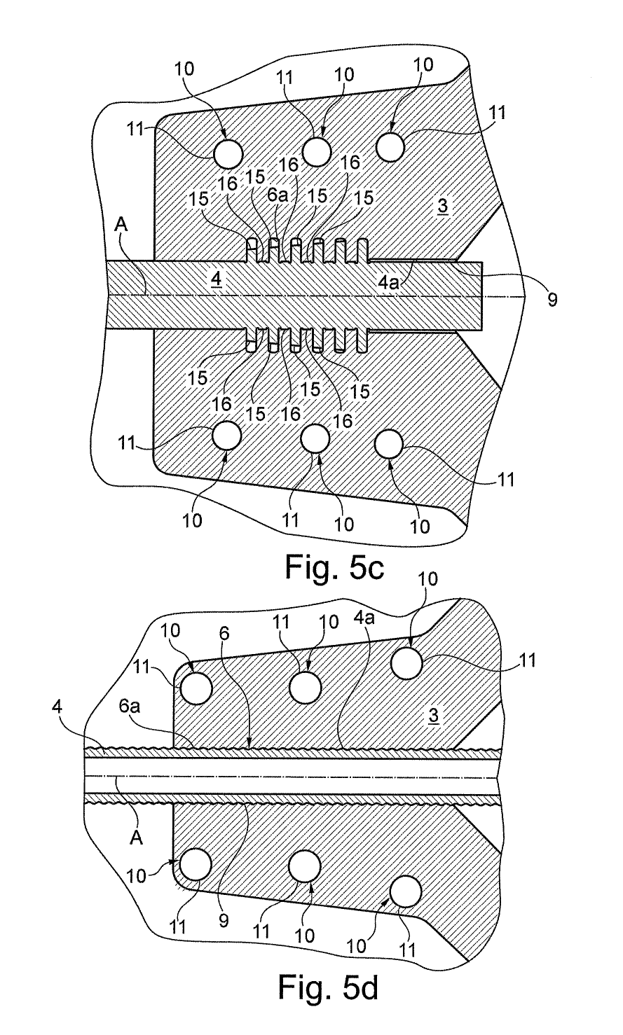

Additionally, in the embodiment shown in FIG. 5b is shown that the piston rod 4 can also be provided with at least one shoulder 13, configured to contact the main body 3. In an embodiment, the piston rod 4 can be provided with two shoulders 13. In this case, the engagement surface 4a of the piston rod 4 is defined between the two shoulders 13. If the distance between the two shoulders 13 is wider than the lateral surface 6a one or two gaps 14 will be defined between the main body 3 and the shoulders 13.

These gaps 14 can either stay empty if the load transmission is left to the friction between the piston rod 4 and the second seat 6. Otherwise, a filler element (not shown) can be inserted in one or both of the gaps 14. More particularly, this can be used to fine-tune the piston-crosshead-cylinder assembly inside a reciprocating compressor.

In an embodiment of the invention, shown in FIG. 1, the lateral surface 6a is a semicylindrical surface. Within the present disclosure, the term “semicylindrical surface” is meant as half the lateral surface of a right circular cylinder cut along an axial plane of symmetry. In this embodiment, the engagement surface 4a of the piston rod 4 will also be semicylindrical.

In an alternative embodiment, the lateral surface 6a is at least partially a semiconical surface. Within the present disclosure, the term “semiconical surface” is meant as half the lateral surface of a right circular cone cut along an axial plane of symmetry. Specifically, in the embodiment of FIG. 5a the lateral surface 6a is doubly semiconical, meaning that it comprises two semiconical surfaces joined together. In this case the engagement surface 4a of the piston rod 4 will be semiconical. More particularly, the partially semiconical embodiment of the lateral surface 6a can provide an improved hold on the piston rod 4.

In the alternative embodiment of FIG. 5c, the second seat 6 is provided with a plurality of ridges 16 on the lateral surface 6a. These ridges 16 can develop circumferentially around the longitudinal axis “A”. Alternatively, the ridges 16 can be formed out of a single helical structure, in a manner substantially similar to a screw thread. The piston rod 4 is correspondingly provided with teeth 15 on its engagement surface 4a. These teeth 15 also develop around a central axis of the piston rod 4 (corresponding to the longitudinal axis “A” in the drawings) so that they can engage the ridges 16 on the lateral surface 6a of the second seat 6.

In the embodiment shown in FIG. 4c the teeth 15 have progressive growing length from the direction of the piston head to the crosshead 1. More particularly, this solution allows for better handling of compression loads. In a corresponding embodiment (not shown in the figures) the teeth 15 have progressively decreasing length along the same direction. This enables a better handling of traction loads. In further embodiment these profiles of the teeth 15 can be combined together, in order to optimize the load bearing capability for a specific application. Indeed, the profiles of the teeth 16 can either first decrease and then increase, so as to have the maximum length in the middle. Alternatively, the teeth 16 can first decrease and then increase their length, in order to have a tooth 16 of minimum length in the middle. In other words it is possible to vary the shape of the teeth 15 on order to distribute uniformly the load on all teeth 15.

In a further embodiment, shown in FIG. 5d, the lateral surface 6a has a sinusoidal profile in the plane of the longitudinal axis “A”. More generally, any periodic and/or repeating profile that can provide an improved grip on the piston rod 4 can also be used. The choice of the specific profile will be made depending on the requirements of the specific application. In this embodiment the engagement surface of the piston rod 4a has a matching profile to the lateral surface 6a.

In all the described embodiments, the piston rod 4 is held in the second seat 6 primarily by mechanical interference. Indeed, the second seat 6 has an internal diameter which is less than an external diameter of the piston rod 4. More particularly, the difference between the internal diameter of second seat 6 and the external diameter of the piston rod 4 is comprised between 0.05 and 0.3 percent of the external diameter of the piston rod 4, so that the second seat 6 can grip onto the piston rod 4 by mechanical interference.

To join the linking 3a and the closing portions 3b, the crosshead 1 comprises a fastening element 10. Additionally, the fastening element 10 also locks the piston rod 4 in the second seat 6. In greater detail, the fastening element 10 is configured to apply a load to the linking 3a and to the closing portion 3b, in order to push them together in a direction substantially perpendicular to he longitudinal axis “A”.

In some embodiments of the present invention the fastening element can comprise one or more bolts 11. Each bolt 11 develops along a transversal direction “C”, perpendicular to the longitudinal axis “A”. As can be seen from FIG. 1, the fastening element can comprise six bolts 11, symmetrically placed with respect to the bore 9. The number of the bolts 11 can vary as required by the specifications in a particular application.

To assemble the above described crosshead, the operator has to force the piston rod 4 inside the second seat 6. This can be accomplished either by a purely mechanical forcing or by pre-heating the linking portion 3a. If a connecting rod 2 with an integral pin 12 is used, they are also placed in the first seat 5 at this time. The closing portion 3b is then joined to the linking portion. If it is deemed appropriate, the closing portion 3b can also be pre-heated. Alternatively, the piston rod 4 can be cooled.

The portions 3a, 3b are then secured together, in an embodiment with the fastening element 10. Specifically, a load is also applied to the fastening element 10, in order to block the piston rod 4 between the portions 3a, 3b by mechanical interference. This is done more particularly by screwing the nuts on the bolts 11.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A crosshead for a piston rod, the crosshead comprising:
a main body having a first seat and a second seat, the first seat being configured to hold a connecting rod, the second seat being configured to hold a piston rod; the main body comprising a linking portion defining at least partially the first seat and the second seat for holding respectively the connecting rod and the piston rod; the main body comprising a closing portion defining at least partially the second seat and being configured to secure the piston rod inside the second seat.

2. The crosshead according to claim 1, wherein the second seat has a lateral surface configured to engage the piston rod and extending at least along a longitudinal axis, the lateral surface being defined by the linking portion and the closing portion.

3. The crosshead according to claim 1, wherein the lateral surface develops around the longitudinal axis; the linking portion and the closing portion having each an angular extension of 180° with respect to the longitudinal axis.

4. The crosshead according to claim 2, wherein the lateral surface is at least partially complementary to an engagement surface of a piston rod.

5. The crosshead according to claim 2, wherein the lateral surface is a semicylindrical surface.

6. The crosshead according to claim 2, wherein the lateral surface is at least partially a semiconical surface.

7. The crosshead according to claim 4, wherein the second seat is provided with a plurality of ridges on the lateral surface, the ridges being configured to grasp corresponding teeth on the engagement surface.

8. The crosshead according to claim 1, wherein the closing portion further defines at least partially the first seat.

9. The crosshead according to claim 1, wherein the linking portion and the closing portion are substantially symmetrical with respect to a plane perpendicular to a hinge axis of the connecting rod.

10. The crosshead according to claim 1, wherein the linking portion and the closing portion are two half-parts of the main body.

11. The crosshead according to claim 1, wherein a difference between an external diameter of the piston rod and an internal diameter of the second seat is comprised between 0.05 and 0.3 percent of the external diameter, so as to grip onto the piston rod by mechanical interference.

12. The crosshead according to claim 1, further comprising at least a fastening element configured to join the linking and closing portions and for locking the piston rod in the second seat.

13. The crosshead according to claim 1, wherein the fastening element is configured to apply a load to the linking portion and the closing portions for pushing them together in a direction substantially perpendicular to the longitudinal axis.

14. The crosshead according to claim 1, wherein the fastening element comprises a plurality of bolts each developing along a transversal direction, the transversal direction being perpendicular to the longitudinal axis.

15. A method for assembling a crosshead, comprising a main body having a first seat and a second seat, the first seat being configured to hold a connecting rod, the second seat being configured to hold a piston rod; the main body comprising a linking portion defining at least partially the first seat and the second seat for holding respectively the connecting rod and the piston rod; the main body comprising a closing portion defining at least partially the second seat and being configured to secure the piston rod inside the second seat. the method comprising:
joining the linking and the closing portions while placing a piston rod inside the second seat; and
securing the linking and the closing portions together, with the fastening element.

16. The method according to claim 15, further comprising applying a load to the fastening element to block the piston rod between the linking and closing portions by mechanical interference.

17. A kit comprising:
a crosshead comprising a main body having a first seat and a second seat, the first seat being configured to hold a connecting rod, the second seat being configured to hold a piston rod; the main body comprising a linking portion defining at least partially the first seat and the second seat for holding respectively the connecting rod and the piston rod; the main body comprising a closing portion defining at least partially the second seat and being configured to secure the piston rod inside the second seat. and
a piston rod having an engagement surface at least partially complementary to the lateral surface of the second seat of the crosshead.

18. The kit according to claim 17, wherein the piston rod comprises a plurality of teeth on the engagement surface, the teeth being configured to be inserted between corresponding ridges on the lateral surface.

19. The kit of claim 17 further comprising:
a connecting rod configured to be attached to the crosshead and to a crankshaft; and
a pin integrally formed with the connecting rod and adapted to be inserted in the first seat.
